(19) United States
(12) Patent Application Publication
(10) Pub. No.: US 2005/0178205 A1
(43) Pub. Date: Aug. 18, 2005

(54) Method and apparatus for measuring force applied to a fastening bolt

(75) Inventor: David Nitsan, Azur (IL)

Correspondence Address: Martin Moynihan;c/o ANTHONY CASTORINA, SUITE 207, 2001 JEFFERSON DAVIS HIGHWAY, ARLINGTON, VA, 22202, US

(73) Assignee: Nexense Ltd.

(21) Appl. No.: 11/055,625

(22) Filed: Feb. 11, 2005

(30) Foreign Application Priority Data
Feb. 12, 2004 (IL) 160364

(51) Int. Cl. G01L 5/22; G01L 1/00; G01N 29/18

(52) U.S. Cl. 73/597; 73/862.59; 73/761

(57) ABSTRACT

A method and apparatus for measuring the force applied to a fastening bolt by: transmitting a cyclically-repeating energy wave through the fastening bolt; measuring the transit time of the cyclically-repeating energy wave from a first location to a second location; and utilizing the measured transit time to produce a measurement of the force. In a described preferred embodiment, the bolts fastens a seat of a vehicle to the vehicle frame such that the measured transit time provides a measurement of the force applied to the vehicle seat by the seat occupant.

### FIELD AND BACKGROUND OF THE INVENTION

The present invention relates to a method and apparatus for measuring a force applied to a fastening bolt. The invention is especially useful in measuring the force applied to a fastening bolt for fastening a seat to the frame in a motor vehicle, and is therefore described below with respect to such application, but it will be appreciated that the invention is capable of being used in many other applications as well.

One example of a force sometimes requiring precise measurement is the weight of an occupant of a vehicle seat, particularly in controlling the actuation of an airbag. For example, if a vehicle seat is not occupied, there is no reason to actuate the airbag even should there be a sudden impact. Moreover, if the seat is occupied by a small child, it may be desirable to disable actuation of the airbag in order to avoid injuring the child, or otherwise to control the force applied by the airbag to the seat occupant. A force sensor used in such an application should not only be capable of convenient introduction into existing motor vehicles, but should also be highly sensitive and reliable in operation.

### OBJECTS AND BRIEF SUMMARY OF THE PRESENT INVENTION

An object of the present invention is to provide a method, and also apparatus, for measuring the force applied to a fastening bolt having advantages in one or more of the above respects particularly when used in the above-mentioned application in a motor vehicle.

According to one broad aspect of the present invention, there is provided a method of measuring the force applied to a fastening bolt which fastens a first member coupled to a second member, comprising: transmitting a cyclically-repeating energy wave through the fastening bolt from a first location thereon to a second location thereon; measuring the transit time of the cyclically-repeating energy wave from the first location to the second location; and utilizing the measured transit time to produce a measurement of the force.

In some embodiments of the invention described below, the connecting member is a fastening plate which fastens the first member to the second member, and which is strained by the force applied to the first member such that the measured transit time of the cyclically-repeating energy wave represents a measurement of the strain, and thereby a measurement of the force applied to the first member.

As described more particularly below, such a fastening bolt which fastens the first member to the second member, is strained by the applied force such that the measured transit time of the cyclically-repeating energy wave represents a measurement of the strain, and thereby a measurement of the force applied to the first member.

According to another aspect of the invention, there is provided apparatus for measuring the force applied to a fastening bolt in accordance with the above method.

As will be described more particularly below, the method and apparatus including the foregoing features enable such measurements to be made with high precision. In addition, the method may be implemented in apparatus which is of a relatively simple, compact construction, and which is capable of convenient introduction into existing vehicles and of withstanding the harsh environmental conditions therein.

Preferably, and as described more particularly below, the measurement of the deformation in the fastening bolt is effected according to the technique described in U.S. Pat. No. 6,621,278, of Sep. 16, 2003, assigned to the assignee of the present application.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates fastening bolt constructed with a force sensor in according with the invention for sensing whether or not a vehicle seat is occupied by a person and/or for measuring the weight of such person, for use in controlling the inflation of an airbag;

FIG. 2 is a sectional view illustrating the seat sensor arrangement of FIG. 1;

FIG. 3 is an enlarged sectional view illustrating one of the fastening bolts in the seat sensing arrangement of FIG. 1;

FIG. 4 illustrates another construction of the fastening bolt of FIGS. 2 and 3; and

FIG. 5 is a block diagram illustrating the electrical measuring system for measuring the force applied to the fastening bolt illustrated in FIGS. 1-4;

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

As indicated above, the present invention measures the strain or deformations of a fastening bolt fastening two members together in order to provide a measurement of the force applied to the fastening bolt. Such deformations are measured in accordance with the present invention by the electrical measuring system described in the above-cited U.S. Pat. No. 6,621,278, which permits extremely high accuracy to be achieved even with relative small deformations.

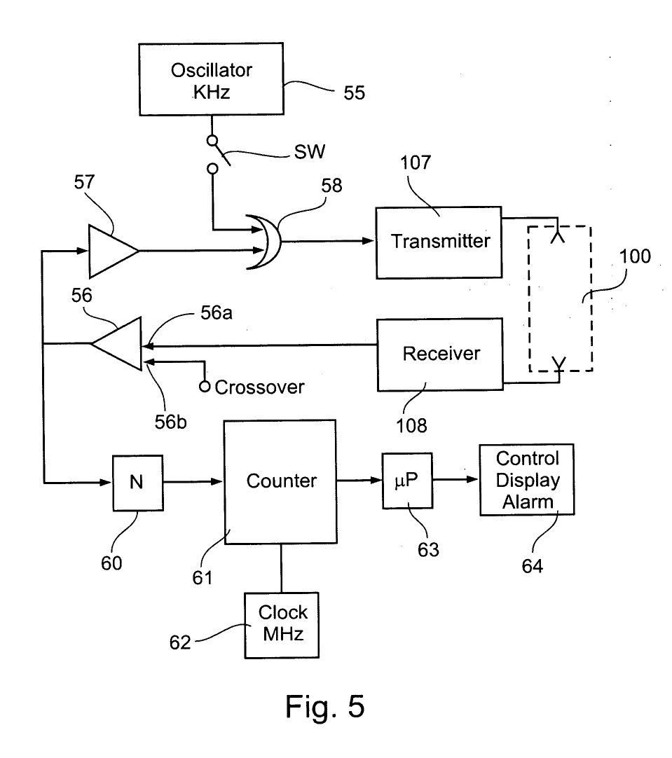

FIG. 5 to be described below schematically illustrates such an electrical measuring system. Broadly speaking, the deformation in the fastening bolt is measured by: transmitting a cyclically-repeating energy wave from one end of the fastening bolt towards the other end; receiving the cyclically-repeating energy wave at the other end of the fastening bolt; detecting a predetermined fiducial point in the received cyclically-repeating energy wave; continuously changing the frequency of transmission of the cyclically-repeating energy wave in accordance with the detected fiducial point of each received wave such that the number of waves received is a whole integer; measuring the change in frequency; and utilizing the measured change in frequency to produce a measurement of the deformation of the fastening bolt.

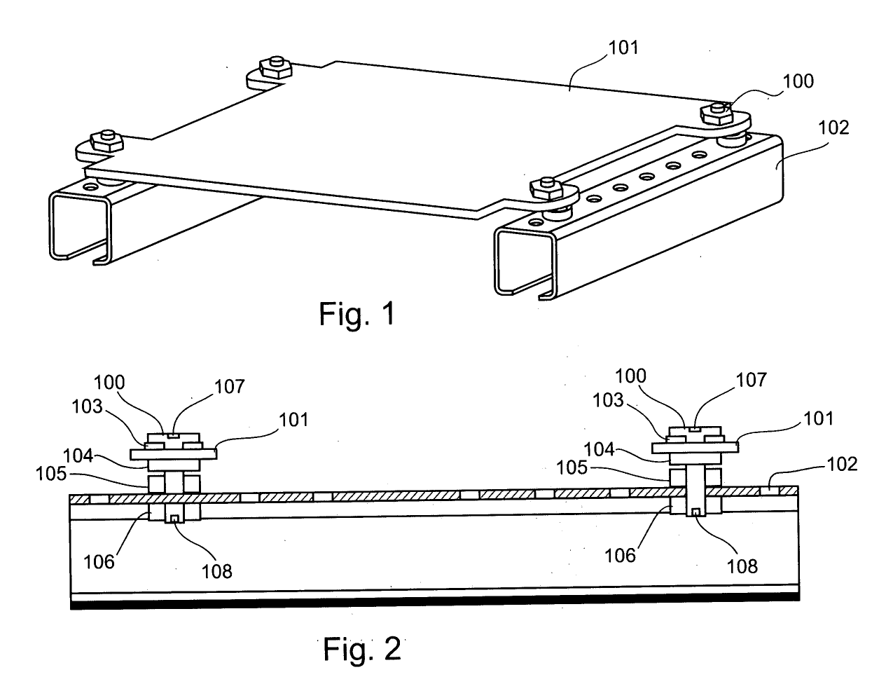

FIGS. 1-3 illustrate an embodiment of the invention wherein the force sensed by the sensor is the force applied to a vehicle seat by the occupant of the seat. Such a sensed force may be used for controlling the actuation of an airbag. For example, if an impact should occur with respect to the vehicle causing actuation of an airbag, the force sensor could be used to disable the actuation of the airbag for a seat found to be unoccupied; or if the occupant is determined to be a small child, the actuation of the airbag for the respective seat could be disabled or reduced so as not to injure the child.

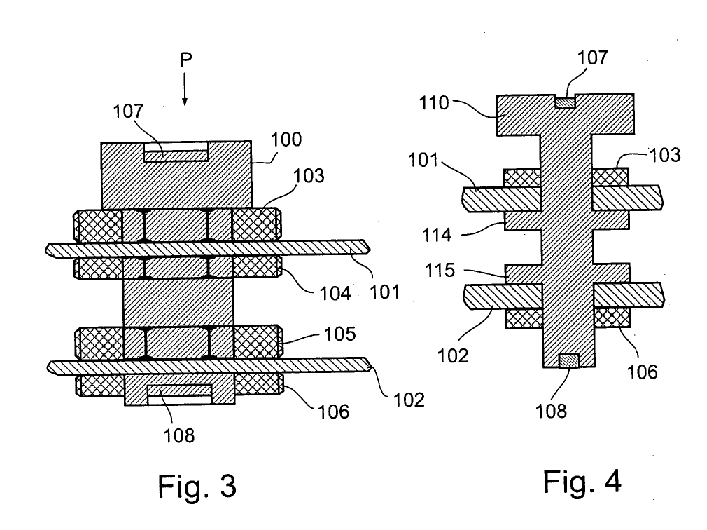

In the embodiment of the invention illustrated in FIGS. 1-3, the fastening member whose strain is measured is a fastening bolt 100 connecting the chair frame 101 to the vehicle chassis 102. Thus as shown more particularly in FIG. 3, the seat frame 101 is secured to the outer end of bolt 100 by a pair of nuts 103, 104; and the vehicle chassis 102 is secured to the inner end of fastening bolt 100 by another pair of nuts 105, 106. It will thus be seen that the force applied by the seat frame 101 to the vehicle chassis 102 will produce an axial strain or deformation of the intermediate portion of fastening bolt 100.

The axial strain or deformation of fastening bolt 100 is detected and measured by a sonic transmitter 107 at the outer end of bolt 100, and a sonic receiver 108 at the inner end of the bolt. Thus, the portion of the bolt between the transmitter and receiver serves as an acoustical channel for the transmitted sonic waves, having a transit length (and thereby a transit time) varying with the strain (contractions and elongations) of the bolt caused by the axial force applied to the bolt. The contractions and elongations of the acoustical channel are measured by the electrical measuring system illustrated in FIG. 5 to produce an electrical output closely correlated to the axial forces applied to the bolt.

Thus, as shown in FIG. 5, the electrical measuring system includes an oscillator 55 for initially driving transmitter 107 via a switch SW until an acoustical wave from the transmitter is received by the receiver 108. Once such a wave is received by receiver 108, switch SW is opened, so that the signals received by receiver 108 are thereafter used for controlling the frequency of transmission of transmitter 107.

As shown in FIG. 5, the signals received by receiver 107 are fed to a comparator 56 via its input 56a. Comparator 56 includes a second input 56b connected to a predetermined bias so as to detect a predetermined fiducial or reference point in the received signal. In the example illustrated in FIG. 5, this predetermine fiducial point is the “0” cross-over point of the received signal, and therefore input 56b is at a zero-bias. Other reference points could be used as the fiducial point, such as the maximum or minimum peak of the received signals.

The output of comparator 56 is fed to an amplifier 57 which is triggered to produce an output wave or signal for each fiducial point (“0” cross-over point) in the signals received by the receiver 108. The signals from amplifier 57 are fed via an OR-gate 58 to the transmitter 107. OR-gate 58 also receives the output from oscillator 55 when switch SW is closed.

Switch SW is opened when transmitter 107 receives a continuous stream of signals from amplifier 57 via OR-gate 58. When switch SW is opened, transmitter 107 will thus transmit at a frequency determined by the fiducial point in the signals received by the receiver 108 and detected by comparator 56 to control amplifier 57. Accordingly, the frequency of transmission by transmitter 107 will be such that the number of waves of the cyclically-repeating energy wave transmitted from transmitter 107 and received by receiver 108 will be a whole integer.

It will thus be seen that while the frequency of the transmitter 107 will change with a change in the distance between it and the receiver 108, as caused by the elongation or contraction of bolt 100, the number of wavelengths in the signal transmitted from transmitter 107 will remain a whole integer. This is because, as explained above, the transmitter 107 transmissions are controlled by the fiducial points (“0” cross-over point) of the signals received by the receiver 108. This change in frequency by the transmitter 107, while maintaining the number of waves between the transmitter and receiver as a whole integer, enables a precise determination to be made of the distance between the transmitter and receiver. Thus, as known:
F=C/λ
where F and C are the frequency and velocity, respectively, of the cyclically-repeating energy wave in the respective medium; and λ is the wavelength.

The “0” cross-over points detected in comparator 56, which are used for controlling the frequency of the transmitter 107, are also fed to a counter 60 to be counted “N” times, and the output is fed to another counter 61 controlled by a clock 62. Counter 61 produces an output to a microprocessor 63 which performs the computations of the force applied to bolt 100 according to the elongations and contractions measured. The output of the microprocessor is applied to a control, display, and/or alarm device 64.

Further particulars as to the measuring system illustrated in FIG. 5 are available in the above-cited U.S. Pat. No. 6,621,278, the contents of which are incorporated herein by reference. It has been found that using such a measuring system for measuring the above-described deformations in fastening bolts produces a force measurement of extremely high precision.

Such a sensor, particularly when using the electrical measuring system described above with respect to FIG. 5, has been found to be so sensitive so as to be able to detect not only the weight, but also the respiratory and cardiac activity of the person occupying the seat fastened by bolts 100 to the vehicle frame. Such a sensor, therefore, can be used not only for detecting the presence and weight of a load on the seat, but also whether the load is a person, and in some cases can also provide an indication of the sex of the occupant person. Such information may be used for disabling the actuation of an airbag, or otherwise controlling the actuation of the airbag for the respective vehicle seat.

FIG. 4 illustrates a modification in the construction of the bolt sensor, therein designated 110. In this modification, the bolt sensor 110 is integrally formed with a pair of spaced flanges 114, 115, at a fixed, known distance apart, to be used instead of the fastening nuts 104 and 105 of FIG. 3, for securing the opposite ends of the bolt to the seat frame 101 and vehicle chassis 102, respectively. In this manner, the distance between the transmitter 107 and receiver 108 is fixed in the unstrained condition of the bolt.

While the invention has been described with respect to preferred embodiments, it will be appreciated that these are set forth merely for purposes of example, and that many other variations, modifications and applications of the invention may be made.

1. A method of measuring the force applied to a fastening bolt which fastens a first member to a second member, comprising:
transmitting a cyclically-repeating energy wave through said fastening bolt from a first location thereon to a second location thereon;
measuring the transit time of said cyclically-repeating energy wave from said first location to said second location;
and utilizing the measured transit time to produce a measurement of said force.

2. The method according to claim 1, wherein said first and second locations are spaced from each other along the axis of said fastening bolt, such that the force measured is the axial force applied to said fastening bolt.

3. The method according to claim 1, wherein said first member is fixed to a seat of a vehicle, and said second member is fixed to the vehicle frame, such that said measured transit time provides a measurement of the force applied to the vehicle seat by the seat occupant.

4. The method according to claim 3, wherein said measured transit time is utilized to produce a measurement of the weight of an object on the vehicle seat.

5. The method according to claim 4, wherein said measured transit time is also utilized to indicate respiratory and/or cardiac activity by the seat occupant.

6. The method according to claim 5, wherein said measured transit time is used to control an airbag within the vehicle.

7. The method according to claim 1, wherein the transit time of said cyclically-repeating energy wave from said first location to said second location is measured by:
detecting a predetermined fiducial point in the cyclically-repeating energy wave received at said second location;
continuously changing the frequency of transmission of the cyclically-repeating energy wave in accordance with the detected fiducial point of each received wave such that the number of waves received is a whole integer;
and utilizing the measured change in frequency to produce a measurement of said transit time of the cyclically-repeating energy wave from said first location to said second location.

8. The method according to claim 7, wherein said cyclically-repeating energy wave is an acoustical wave.

9. Apparatus for measuring the force applied to a fastening bolt which fastens a first member coupled to a second member, comprising:
a transmitter at a first location on said fastening bolt for transmitting a cyclically-repeating energy wave through said fastening bolt to a second location thereon;
a receiver at said second location on said fastening bolt for receiving said cyclically-repeating energy wave;
and an electrical system for measuring the transit time of the cyclically-repeating energy wave from said first location to said second location to thereby produce a measurement of the force applied to said fastening bolt.

10. The apparatus according to claim 9, wherein said electrical system measures said transit time by:
detecting a predetermined fiducial point in the cyclically-repeating energy wave received at said second location;
continuously changing the frequency of transmission of the cyclically-repeating energy wave in accordance with the detected fiducial point of each received wave such that the number of waves received is a whole integer;
and utilizing the measured change in frequency to produce a measurement of said transit time of the cyclically-repeating energy wave from said first location to said second location.

11. The apparatus according to claim 10, wherein said cyclically-repeating energy wave is an acoustical wave.

12. The apparatus according to claim 10, wherein said first member is fixed to a seat of a vehicle, and said second member is fixed to the vehicle frame, such that said electrical system utilizes said measured transit time to provide an indication of the force applied to the vehicle seat by the seat occupant.

13. The apparatus according to claim 12, wherein said vehicle further includes an airbag, and said electrical system controls the actuation of said airbag in response to said measured transit time.
